(19) United States
(12) Patent Application Publication
(10) Pub. No.: US 2009/0162489 A1
(43) Pub. Date: Jun. 25, 2009

(54) EFFERVESCENT TABLET FOR USE AS AN ADDITIVE IN HOT COFFEE OR HOT WATER AND METHOD OF MAKING SAME

(76) Inventor: Harjit Singh, Woodbridge, CT (US)

Correspondence Address: GRAY ROBINSON, P.A., P.O. Box 2328, FT. LAUDERDALE, FL, 33303-9998, US

(21) Appl. No.: 12/340,099

(22) Filed: Dec. 19, 2008

Related U.S. Application Data
(60) Provisional application No. 61/008,248, filed on Dec. 19, 2007.

(51) Int. Cl. A23C 11/00; A23P 1/02; A23F 5/42; A23C 9/18; A23C 13/00; A23F 5/38

(52) U.S. Cl. 426/72; 426/561; 426/562; 426/454; 426/410

(57) ABSTRACT

An effervescent tablet for direct use as an additive in hot coffee or hot water includes one or more creamer additives, pH stabilizing agents, effervescence agents, and solubility agents. In one embodiment, the tablet includes dry coffee and, in another embodiment, the tablet excludes it. The creamer additive(s) may be dairy and/or non-dairy. The effervescence agent(s) includes sufficient effervescence to separate the tablet upon placement of the tablet in the hot coffee or water and, in one embodiment, to further create foam on the surface of the coffee so as to yield an instant frothy latte or cappuccino. The pH stabilizing agent(s) stabilizes a pH of the coffee and the solubility agent(s) facilitates expeditious dissolution of the tablet in the coffee or water. Various other ingredients and agents may be included in the tablet to enhance flavor, improve mouth feel, enhance foam production, or achieve other desired characteristics or results.

### CROSS-REFERENCE TO RELATED APPLICATIONS

This application claims priority under 35 U.S.C. §119(e)(1) upon U.S. Application Ser. No. 61/008,248, which is entitled “Coffee Soluble, Effervescent Table for Use as an Additive in Hot Coffee and Method of Making Same” and is incorporated herein by this reference.

### BACKGROUND OF THE INVENTION

1. Field of the Invention

This invention relates generally to dry additives, such as powdered milk and powdered non-dairy creamers, for direct use in hot coffee or hot water and, more particularly, to an effervescent tablet for direct use as an additive in hot coffee or hot water.

2. Description of Related Art

Traditionally, cappuccinos and lattes are prepared by taking fresh milk, whether skim or whole (fall fat), and steaming it before adding it to an espresso coffee. The steaming process is performed using a machine that whips the milk and creates foam. The steaming and foaming (i.e., frothed) milk is then added over the coffee to produce a latte. A cappuccino is produced by pouring the frothed milk into the cup before the coffee. A latte typically has a higher percentage of milk and lower foam, while a cappuccino typically has less milk and greater foam. Milk that is not steamed or foamed has a flat and dull taste by comparison.

Powdered creamers have been offered as alternatives to fresh milk within the vending industry to allow vending machines to produce and dispense cappuccino and latte beverages. The vending machines mix the powders with water to produce hot, foaming milk and then dispense the hot milk and coffee into beverage cups as appropriate to form latte or cappuccino drinks. Various milk powders, including free flowing agglomerated milk powders, are being used by coffee vending machine operators to offer frothy drinks, such as lattes and cappuccinos, in environments where fresh milk is not easily available. Even manufacturers of non-dairy creamers (coffee whiteners) have promoted products made with corn syrup solids, vegetable oils and artificial ingredients to be used in a vending machine as an alternative to powdered milk in order to produce imitation lattes and cappuccinos. Unfortunately, what many non-dairy creamer manufacturers have not realized is that the protein in the milk creates the froth when the milk is whipped. Thus, vending machines using agglomerated milk powders instead of non-dairy creamers produce much more stable foam to allow the rich taste of steamed milk to come out in a vended cappuccino or latte drink. As a result, consumers' acceptance of cappuccinos and lattes produced in vending machines using non-dairy creamers with poor froth capabilities has been limited.

As an alternative, some companies have taken the additional step of injecting an inert gas, such as nitrogen or carbon dioxide, into the powdered creamers to produce a water soluble powder or tablet that creates foam. One such water soluble powder and tablet is disclosed in U.S. Pat. No. 6,953,592 B2 to Darbyshire et al. Most of these foaming creamer products are formed by infusing a carbohydrate matrix with maltodextrin, corn syrup solids and other sugars. The foaming creamers are then added as a base to cocoa, sugar, coffee, and flavors to make frothy hot or cold beverages or are used to make soups, desserts, and/or sauces as described in U.S. Pat. No. 5,462,759.

Unfortunately, none of the foaming creamer products developed to date have the capability or solubility to be mixed directly into a hot cup of coffee to make a truly drinkable instant cappuccino. Instead, all the foaming creamer products are designed to be used as fillers. The fillers have the capability of foaming when added to hot water, but when the fillers are poured directly on top of a cup of hot coffee, the fillers lump, clump and float on the coffee's surface. The lumps of powder form at the top of the surface as they cling to the bubbles formed by the effervescent gases. Because the gases in the foaming creamers effervesce immediately upon contacting the hot coffee and rise to the top of the water surface, the gases prevent the powder creamer from sinking into the coffee and dissolving. In other words, the same gases that help in creating the foam also prevent the powder from dissolving. Once the incorporated gases contact the water, they tend to surface, retaining with them the powder particles and preventing an immediate dissolution of the particles in the coffee. An individual can vigorously stir the clumped powder and be successful, over time, dissolving most of the powder, particularly if the powder is agglomerated or freeze dried, but such vigorous stirring is not a typical part of enjoying a true latte or cappuccino.

Alternatively, a user may place the foaming creamer powder in the bottom of the cup prior to pouring the hot water or coffee into the cup to improve the likelihood that the powder will dissolve into the beverage. Some manufacturers of foaming creamers now specifically request on the packaging and in their directions that their customers pour the powder first into the cup and then pour the coffee on top to get better results. However, in reality, consumers oftentimes do not follow directions listed on the packaging and, therefore, will pour the coffee first and then add the powder. This is especially true in in commercial environments, such as restaurants, where the coffee is pre-poured and then brought to the customers for them to add their condiments. As a result, when the foaming creamers are poured into the cup of coffee, they coagulate and form clumps, which will not likely be conceived as true lattes or cappuccinos by their consumers.

Therefore, a need exists for an effervescent tablet, and associated method of making same, that includes a creamer additive and that dissolves when added by a user to a cup of hot coffee or that includes a creamer additive in combination with dry coffee and that dissolves when added to a cup of hot water, without the need for vigorous agitation by the user. Such a tablet that also includes sufficient effervescence to create a foam, so as to produce a latte or cappuccino beverage when added to a cup of hot coffee or hot water, would be a further improvement over the prior art.

### BRIEF DESCRIPTION OF THE DRAWINGS

FIG. 1 illustrates an effervescent tablet in accordance with an exemplary embodiment of the present invention.

FIG. 2 is a logic flow diagram illustrating steps executed to fabricate an effervescent tablet in accordance with an exemplary embodiment of the present invention.

### DETAILED DESCRIPTION OF EXEMPLARY EMBODIMENT(S)

Before describing in detail exemplary embodiments that are in accordance with the present invention, it should be observed that the embodiments reside primarily in an effervescent tablet and associated fabrication method. Accordingly, the tablet and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element. The term “tablet” as used herein means any non-powdered solid having a mass greater than or equal to ten (10) milligrams and includes, without limitation, a conventional tablet, a crystal, a pellet, a granule, a grain, a cake, or a flake, regardless of size or geometric shape.

Generally, the present invention encompasses an effervescent tablet for direct use as an additive in a cup of hot black coffee or hot water. In one embodiment, the tablet includes, inter alia, at least one creamer additive, at least one pH stabilizing agent, at least one effervescence agent, and at least one solubility agent, but excludes any dry coffee. In an alternative embodiment, the tablet also includes dry (e.g., freeze dried) coffee. The creamer additive may be dairy or non-dairy. The effervescence agent includes sufficient effervescence to separate the tablet upon placement of the tablet in the hot coffee or water. In a preferred embodiment, the effervescent agent includes sufficient effervescence to create foam on the surface of the hot coffee after the tablet has been added to the hot coffee or water so as to yield an instant frothy latte or cappuccino, in a measured proportionate form. The pH stabilizing agent stabilizes the pH of the hot coffee into which the tablet is to be placed or which forms part of the tablet. The solubility agent and optional excipients facilitate expeditious dissolution of the tablet in the hot coffee or water into which the tablet is to be placed. Various other ingredients and agents may be included in the tablet to enhance flavor, improve mouth feel, improve nutrition, enhance foam production, or achieve any other desired characteristics or results.

In one embodiment for use in hot coffee, the tablet is fabricated by combining at least one of water and milk together with at least one creamer additive and at least one pH stabilizing agent to form a mixture. The mixture is then homogenized and pasteurized. The pasteurized result is infused with at least one effervescence agent to form an effervescent mixture. The effervescent mixture is dried (e.g., spray dried) and at least one solubility agent is added (e.g., at the time of agglomeration) to form a dried mixture. The dried mixture is then compacted to form the tablet. In an alternative embodiment, the dried (e.g., agglomerated) mixture may be formed into a tablet using extrusion or other conventional configuration techniques. Optionally, but more preferably, one or more additional effervescence agents and/or excipients may be added to the dried mixture prior to compaction. Still further, the effervescent mixture, whether including a dairy or non-dairy creamer additive, may be freeze dried rather than spray dried prior to compaction or other final configuration.

By formulating a coffee soluble, effervescent tablet in this manner, the tablet may be dropped in or otherwise added to a hot cup of black coffee so as to add dairy and/or non-dairy creamer to the coffee with minimal or no coagulation or clumping. The tablet of the present invention sinks at least partially below the surface of the coffee, and more preferably to the bottom of the cup, to insure that most or all of the tablet's ingredients slowly dissolve below the surface of the coffee and are released by the effervescent expansion of the infused effervescent agents (e.g., gases, citric acid, and/or sodium bicarbonate). In one embodiment in which the amount and type of effervescent agents are selected so as to produce a cappuccino or latte beverage when one or more of the tablets are placed in a cup of hot coffee, the effervescent expansion of the infused effervescence agents gradually form a smooth rich foam with smooth bubbles on the surface of the coffee, such as is obtained when steaming milk is poured into a cup of coffee to make a latte or cappuccino. However, in contrast to the production of conventional lattes or cappuccinos with separate steaming machines, cappuccinos and lattes produced pursuant to the present invention are so produced instantly by simply adding the coffee soluble, effervescent tablet into a cup of hot coffee, without having to use traditional cappuccino machines and/or steaming fresh milk.

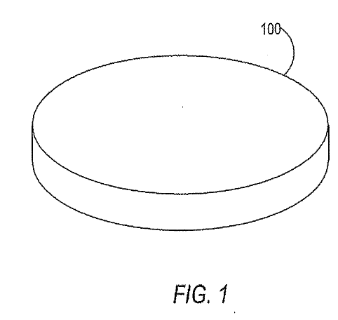

FIG. 1 illustrates an effervescent tablet 100 in accordance with an exemplary embodiment of the present invention. The tablet 100 illustrated in FIG. 1 is disc-shaped, but may be any other desired shape. In accordance with one embodiment of the present invention, the tablet 100 includes, among other things, at least one creamer additive, at least one pH stabilizing agent, at least one effervescence agent, and at least one solubility agent, but excludes any dry coffee. The creamer additive(s) may be dairy (e.g., milk), non-dairy (e.g., coffee whiteners, non-dairy creamers, soy proteins, vegetable fat and/or carbohydrates), or both (e.g., milk caseinates and corn syrup solids). The pH stabilizing agent(s) may be one or more of disodium phosphate and sodium citrate. The effervescence agent(s) preferably includes a gas, such as nitrogen and/or carbon dioxide, and may optionally include citric acid and/or sodium bicarbonate.

For example, in one embodiment, the tablet 100 may contain dairy and/or non dairy ingredients, infused with gases (e.g., carbon dioxide and/or nitrogen), that are spray dried or freeze dried and include processing aids, such as stabilizers and buffers (e.g., disodium phosphate and/or sodium citrate) to regulate the pH of the coffee. The tablet 100 may also include a solubility agent, such as lecithin, and optionally one or more excipients (e.g., croscarmellose sodium and/or microcrystalline cellulose) to expeditiously dissolve and disintegrate the tablet, as well as added effervescence agents (e.g., citric acid and/or sodium bi-carbonate) to assist with breaking or separating the tablet 100 after being dropped or otherwise added to the coffee and optionally creating a surface foam to produce a cappuccino or latte beverage. A variety of flavors and sweeteners (e.g., sugar; aspartame, saccharin, vanilla, hazelnut, amaretto, or any other flavor or sweetener), as well as mouth feel agents (e.g., one or more gums, such as carrageenan, guar gum, or acacia gum) may be optionally added. The resulting tablet 100 is an instant soluble creamer tablet that, when dropped in a cup of coffee, dissolves and creates a tasteful, preferably foamy effervescent cup of coffee substituting for fresh milk to make, in one embodiment, a rich frothy latte or cappuccino.

The coffee soluble, effervescent tablet 100 will work for both dairy and non-dairy creamer products. The tablet 100 is shelf stable and can be easily dropped in a regular cup of coffee to create a creamed coffee or, more preferably, a foamy, frothy cappuccino or latte drink. The tablet 100 of the present invention provides an excellent alternative to foaming creamer powders that will clump, to milk that has to be steamed in professional machines, to vending powders that require vending machines to whip the powder, and/or to other homemade devices that require whipping the milk to get a frothy result. The present invention allows individuals to quickly create their own lattes or cappuccinos by simply adding the tablet 100 to a hot cup of coffee—for example, at home, in restaurants, in offices, in planes, in trains or at any location or occasion where coffee is served.

A range of products can be formulated to produce the coffee soluble, effervescent tablet 100 of the present invention. For instance, the creamer additive may be 100% natural milk or dairy cream with added dairy protein. The fat solids content of the milk is preferably no greater than about 72% by weight. Protein content is also important for creating foam in combination with the appropriate amount of effervescence. When milk is used as the creamer additive, the milk preferably has a protein content of no greater than about 50% by weight and, more preferably, between 2% and 50% by weight. When cream is used alone or in combination with milk, the milk and/or cream combination preferably includes a carbohydrate content of not more than about 55% by weight and, more preferably, between 2% and 55% by weight. Conventional cream may be substituted by a flavored cream, such as vanilla, hazelnut, amaretto, or Dulce de Leche, to enable consumers to replace refrigerated flavors and have an instant frothy flavored cappuccino.

To produce a latte or cappuccino beverage, the quantity of effervescence agent(s) included in the tablet 100 should be sufficient to not only separate at least some of the tablet, but also create foam on a surface of the hot coffee after the tablet has been added to the hot coffee. A tablet with low effervescence agent levels can alternatively be produced using dairy or non-dairy ingredients to provide an instant, non-foaming creamer for use in a hot cup of coffee. In this non-foaming embodiment, the effervescence agent(s) need only be sufficient to separate some or all of the tablet 100, but need not be sufficient to create foam on the coffee's surface.

When the creamer additive is non-dairy, the additive may include non-dairy proteins (e.g., egg protein, soy protein, and/or sodium caseinate) and the protein content of the non-dairy creamer is preferably not more than about 50% by weight. Plain non-dairy creamer may be substituted by a flavored creamer to enable consumers to replace refrigerated flavors and have an instant frothy flavored cappuccino. Vitamins and/or sweeteners, such as sugar, aspartame, saccharin, or sucralose, can be added to either the dairy creamer additive or the non-dairy creamer additive to improve taste.

Tablets 100 using dairy and non dairy creamer additives were formulated, The dairy tablets contained different levels of dairy fat and protein. One formulation included 24.5% by weight skim milk solids, 44.2% by weight cream having 38% fat solids content, 0.3% by weight guar gum, 0.2% by weight butylated hydroxytolune (BHT) (antioxidant to prevent rancidity when high fat content is used), 1.5% by weight disodium phosphate, and 29.3% by weight lactose. The formulation was dissolved in a mixing tank with water, heated to 70° C., two-stage homogenized (110 bar—1^{st} stage, 35 bar—2^{nd} stage), pasteurized at 80° C., and infused with carbon dioxide (CO₂) at 0.1 g/sec or 36 kg/h (based on a capacity of the drier of 75 kg of powder per hour). The powder was then dried and agglomerated on a belt dryer. Depending upon the amount of fat in the creamer additive, lecithin can also be applied on the powder at the time of final drying to enable to improve solubility.

Similarly, liquid milk or cream can also be freeze dried into solid form with infusion of nitrogen taking place during the freeze drying process and forming a powder mix. Additional effervescence agents, such as sodium bicarbonate (e.g., 0.35% by weight) and/or citric acid (e.g., 0.25% by weight), can be added to the powder mix prior to final formation or configuration of the mix into a tablet. For example, in one exemplary tablet, 3.5 grams of sodium bicarbonate and 2.5 grams of citric acid were added for every kilogram of powder mix. The above formulations can be varied to increase or decrease fat. For example, milk solids or sodium caseinate can be added to increase protein and reduce fat. Additionally, non-dairy creamers and flavored creamers with foam can be processed and formed into a tablet. To mitigate the risk of damage to the tablet and extend the shelf life, the finished moisture level of the tablet should not exceed about 3.0% and preferably should be between about 1.5% and about 2.5%.

Other tablet formulations that include a dairy creamer additive may also include, together with the effervescence agent(s), pH stabilizing agent(s), and solubility agent(s), dairy fat of not more than about 72% by weight of total solids, skim milk solids of not greater than about 20% by weight and preferably between about 2% to about 20% by weight, lactose not greater than about 55% by weight and preferably between about 2% to about 55% by weight, sodium caseinate not greater than about 20% by weight and preferably between about 0.2% to about 20% by weight, or any combination thereof. Tablet formulations that include non-dairy creamer additives may include, together with the effervescence agent(s), pH stabilizing agent(s), and solubility agent(s), vegetable fat solids not more than about 50% by weight, carbohydrates (such as maltodextrin, corn-syrup solids, sucrose, or any other comparable carbohydrates) of not more than about 90% by weight and preferably between about 2% to about 90% by weight, sodium caseinate not greater than 50% by weight and preferably not greater than about 10% by weight, or any combination thereof. Ancillary ingredients, additives, and processing aids that may be included in either dairy formulations or non-dairy formulations include flavor additives, stabilizers, excipients, buffers, vitamins, and mouth feel additives, such as gums. These additives together with the effervescence agent(s), pH stabilizing agent(s), and solubility agent(s) preferably constitute not more than about 15% by weight.

In an alternative embodiment, the tablet 100 may include dry coffee, such as freeze dried, spray dried, agglomerated or instantized coffee, in addition to the one or more creamer additives, pH stabilizing agents, effervescence agents, solubility agents, and optional other ingredients or additives described above. In this case, the tablet 100 may be placed in a hot cup of water to create a foaming coffee product, such as a latte or cappuccino. When coffee is included in the tablet 100, the coffee may form between about 2% and about 20% of the tablet by weight and the by-weight percentages of the various other tablet ingredients would be appropriately adjusted to take into account the presence of the dry coffee.

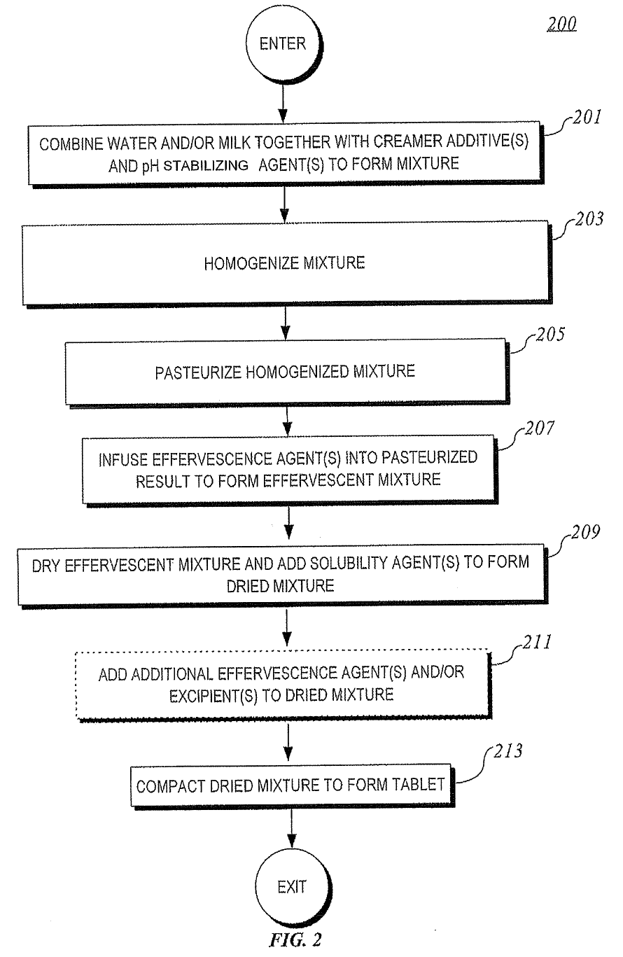

FIG. 2 is a logic flow diagram 200 illustrating steps executed to fabricate a coffee soluble tablet in accordance with an exemplary embodiment of the present invention. Water and/or milk is combined (201) together with at least one creamer additive and at least one pH stabilizing agent (e.g., disodium phosphate and/or sodium citrate) to form a mixture. Water may be used when the creamer additive is a non-dairy creamer and milk may be used when milk or another dairy product (e.g., cream or sodium caseinates) is the creamer additive. The mixture is then homogenized (203) and pasteurized (205). The pasteurized result is infused (207) with at least one effervescence agent to form an effervescent mixture. For example, the pasteurized result may be infused with an inert gas, such as nitrogen, or another gas, such as carbon dioxide. The effervescent mixture is dried (209) and at least one solubility agent, such as lecithin, is added (209) to form a dried mixture. Drying may be accomplished by spray drying, agglomerating or, more preferably, freeze drying. Additional effervescence agents and/or excipients may be optionally added (211) to the dried mixture as desired to improve solubility and enhance effervescence. The dried mixture is then compacted (213), extruded, or otherwise configured to form the tablet.

In one embodiment, the tablet may be formed by using agglomerated powder or freeze dried mix and adding, prior to compacting or extrusion, any flavors, excipients, and additional effervescence agents, such as sodium bicarbonate or citric acid. The general objective is to make a fast dissolving/disintegrating tablet. The excipients which were found to be most effective are croscarmellose sodium, mannitol, and microcrystalline cellulose, although other excipients may be used as desired. Other disintegrants and excipients that may be included are crospovidone and sodium starch glycolate. Selection of the type and quantity of excipients is based on particle size and flowability needs.

To retain the gases and to obtain rapid dissolution, the tablet should be made with a low compaction pressure, preferably less than 100 pounds-force per square inch gauge (psig), when compaction is used for final tablet configuration. It is also preferable, but not necessary, to vary the compaction pressure based on the long term stability of the tablet, which can vary based on the ingredients, the fat and the size of the tablet. To insure that a desired amount of ingredients is dispensed in the coffee when the tablet is placed therein, the size of the tablet can be varied based on the type of ingredients to be dispensed. While a low compaction pressure was found to provide the best results, compaction pressure can be increased to as much as 1000 psig to formulate the tablet with acceptable dissolution results.

In an alternative embodiment in which the tablet includes dry coffee, the dry coffee may be added to the dried mixture produced at step 209 of FIG. 2 prior to compaction or other formation of the tablet. For example, the dry coffee may be added together with additional effervescence agents and/or excipients as discussed above with respect to step 211. The dried, coffee-containing mixture would then be formed into a tablet as discussed above with respect to step 213. Such a tablet could then be placed in hot water to produce an instant cup of latte or cappuccino.

Packaging may also be an important part of fabricating the tablet for commercial use. In order to preserve the integrity of the final product, the tablet may be packed in a low humidity environment (e.g., below about 10% relative humidity) with a packaging material having a vapor transmission of zero. In order to retain their effervescent qualities, effervescent tablets should not be exposed to water or high humidity because the moisture will cause the infused gases to be released prior to the tablet being used. Failure to package the tablet in a low humidity environment may result in a poor quality product that will not rapidly dissolve when placed in coffee. Additionally, to keep the tablet or tablets from being exposed to moisture after packaging, the packaging should be well sealed and water-proof. In one embodiment, the tablet packaging is a foil pack or sachet that has a minimum thickness of 0.5 μm, with a preferred thickness of about 1 μm. Additionally, the tablet may be flushed with nitrogen at the time of packing to further enhance shelf life, particularly when the creamer additive in the tablet contains a high level of fat. Tests have shown that, when fat is involved, the presence of oxygen greater than about 5% in the packaging will result in rapid deterioration and rancidity of the tablet.

As described above, the present invention encompasses a dry, coffee soluble effervescent tablet for direct use as an additive in a cup of hot coffee or hot water, and a method of making same. With this invention, a foaming creamer can be added to a cup of coffee in the form of a self-dissolving tablet that sinks in the coffee. Alternatively, foaming coffee containing dairy or non-dairy creamer and other ingredients can be added to a cup of hot water in the form of a self-dissolving tablet that sinks in the water. The tablet formulation disclosed herein enables the dairy or non-dairy ingredients of the tablet to dissolve instantly when placed in a cup of coffee or hot water overcoming the pH instability of the coffee when it interacts with the infused gas of the tablet to form, in one embodiment, a foamy, frothy drink similar to that of a cappuccino or latte prepared in a professional coffee shop. Prior art foaming creamers are all in powder form and are used as fillers with other products. Despite vigorous mixing of these prior art powdered creamers when added to a hot cup of coffee, the powder oftentimes remains on the surface of the coffee and does not offer the pleasant experience of a latte or cappuccino that the consumer is seeking. The failure of the powdered foaming creamers to overcome the pH reaction of the coffee and to sink below the surface of the coffee substantially impairs their ability to dissolve in the coffee, sometimes even under application of vigorous stirring by the user. Similarly, water soluble powders and tablets providing effervescence have not considered the need of dissolving the powder directly into coffee using dissolution aids and an extremely well agglomerated powder or a freeze dried powder with proper pH stabilization to reconcile the effects of the gases and balance the pH stability of the coffee and the reaction it can cause. The present invention overcomes these deficiencies of the prior art as detailed above.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all of the claims. The invention is defined solely by the appended claims including any amendments made during the pendency of this application and all equivalents of those claims as issued.

What is claimed is:

1. A coffee soluble tablet for direct use as an additive in hot coffee, the tablet comprising:
at least one creamer additive;
at least one pH stabilizing agent that stabilizes a pH of the hot coffee into which the tablet is to be placed;
at least one effervescence agent having sufficient effervescence to at least separate the tablet upon placement of the tablet in the hot coffee; and
at least one solubility agent that facilitates expeditious dissolution of the tablet in the hot coffee into which the tablet is to be placed,
wherein the tablet excludes any dry coffee.

2. The tablet of claim 1, wherein the at least one creamer additive comprises at least one of milk and cream.

3. The tablet of claim 2, wherein the milk has a fat content of no greater than about 72% by weight.

4. The tablet of claim 2, wherein the milk has a protein content of no greater than about 50% by weight.

5. The tablet of claim 2, wherein the at least one of milk and cream includes a carbohydrate content of not more than about 55% by weight.

6. The tablet of claim 1, wherein the at least one creamer additive includes a non-dairy creamer.

7. The tablet of claim 6, further comprising vegetable fat and carbohydrates.

8. The tablet of claim 6, wherein the non-dairy creamer has a protein content of at least 50% by weight.

9. The tablet of claim 1, wherein the at least one pH stabilizing agent is at least one of disodium phosphate and sodium citrate.

10. The tablet of claim 1, wherein the at least one solubility agent includes at least one excipient.

11. The tablet of claim 10, wherein the at least one excipient is at least one of croscarmellose sodium, microcrystalline cellulose, mannitol, crospovidone, and sodium starch glycolate.

12. The tablet of claim 1, wherein the at least one solubility agent includes lecithin.

13. The tablet of claim 1, wherein the at least one effervescence agent is sufficient to create foam on a surface of the hot coffee to produce a cappuccino beverage after the tablet has been added to the hot coffee.

14. The tablet of claim 1, wherein the at least one effervescence agent is sufficient to create foam on a surface of the hot coffee to produce a latte beverage after the tablet has been added to the hot coffee.

15. The tablet of claim 1, wherein the at least one effervescence agent comprises a gas.

16. The tablet of claim 15, wherein the gas is at least one of nitrogen and carbon dioxide.

17. The tablet of claim 1, wherein the at least one effervescence agent comprises at least one of citric acid and sodium bicarbonate.

18. The tablet of claim 1, further comprising a flavor additive.

19. The tablet of claim 1, further comprising a sweetener.

20. The tablet of claim 1, further comprising vitamin additives.

21. The tablet of claim 1, further comprising a mouth feel agent.

22. The tablet of claim 21, wherein the mouth feel agent includes at least one gum.

23. A method for producing a coffee soluble tablet for direct use as an additive in hot coffee, the method comprising:
combining at least one of water and milk together with at least one creamer additive and at least one pH stabilizing agent to form a mixture, the at least one pH stabilizing agent stabilizing a pH of the hot coffee into which the tablet is to be placed;
homogenizing the mixture to form a homogenized mixture;
pasteurizing the homogenized mixture to form a pasteurized mixture;
infusing at least one effervescence agent into the pasteurized mixture to form an effervescent mixture;
drying the effervescent mixture and adding at least one solubility agent to form a dried mixture, the solubility agent facilitating expeditious dissolution of the tablet in the hot coffee into which the tablet is to be placed; and
compacting the dried mixture to form the tablet.

24. The method of claim 23, further comprising:
adding at least one additional effervescence agent and at least one excipient to the dried mixture prior to the compacting step.

25. The method of claim 23, wherein the step of drying comprises:
freeze drying the effervescent mixture to form the dried mixture.

26. The method of claim 23, wherein the step of compacting comprises:
compacting the dried mixture using a compaction pressure of not more than about 1000 pounds-force per square inch gauge.

27. The method of claim 26, wherein the step of compacting comprises:
compacting the dried mixture using a compaction pressure of not more than about 100 pounds-force per square inch gauge based at least on dimensions of the tablet.

28. The method of claim 23, further comprising:
packaging the tablet in a low humidity environment.

29. The method of claim 23, further comprising:
packaging the tablet in a foil sachet having a minimum thickness of 0.5 μm.

30. The method of claim 29, further comprising:
flushing the tablet with nitrogen prior to packaging the tablet in the foil sachet.

31. A coffee soluble tablet for direct use as an additive in hot water, the tablet comprising:
dry coffee;
at least one creamer additive;
at least one pH stabilizing agent that stabilizes a pH of the coffee after placement of the tablet in the hot water;
at least one effervescence agent having sufficient effervescence to at least separate the tablet upon placement of the tablet in the hot water; and
at least one solubility agent that facilitates expeditious dissolution of the tablet in the hot water into which the tablet is to be placed.
